(19) United States
(12) Patent Application Publication
(10) Pub. No.: US 2017/0328751 A1
(43) Pub. Date: Nov. 16, 2017

(54) METHOD FOR DETECTION OF PIPELINE VIBRATIONS AND MEASURING INSTRUMENT

(71) Applicant: KROHNE Messtechnik GmbH, Duisburg (DE)

(72) Inventor: Lars Lemke, Duisburg (DE)

(73) Assignee: KROHNE Messtechnik GmbH, Duisburg (DE)

(21) Appl. No.: 15/594,937

(22) Filed: May 15, 2017

(30) Foreign Application Priority Data
May 13, 2016 (DE) 10 2016 108 986.9

(51) Int. Cl. G01F 1/66; G01H 9/00

(52) U.S. Cl. CPC G01F 1/668; G01F 1/662; G01H 9/00

(57) ABSTRACT

A method for detection of pipeline vibrations with a measuring instrument connected to a pipeline system through which a medium to be measured flows, the measuring instrument having at least one transducer for detection of an input variable and for output of an output variable and at least one evaluation unit. The method involves detecting the input variable, relaying of an output variable based on the input variable to the evaluation unit, determinating the measured value of the measured variable from the output variable. Monitoring of the operating state of a system is achieved in that the measured variable characterizes the medium located within the pipeline system, that the sampling rate for detection of the input variable is at least twice as high as the frequency of the pipeline vibration and a frequency analysis of the brief fluctuations of the measured variable is conducted.

### BACKGROUND OF THE INVENTION

### Field of the Invention

The invention relates to a method for detection of pipeline vibrations with a measuring instrument for detecting a measured variable, the measuring instrument being connected to a pipeline system through which the medium which is to be measured flows, and the measuring instrument having at least one transducer for detection of an input variable and for output of an output variable and at least one evaluation unit, comprising the following method steps: detection of the input variable by the transducer, relay of an output variable based on the input variable to the evaluation unit, determination of the measured variable from the output variable by the evaluation unit.

### Description of Related Art

Moreover, the invention relates to a measuring instrument for detection of a measured variable and for attachment to the pipeline system, which instrument is configured such that the medium which is to be measured flows through it, with at least one transducer suitable for detection of an input variable and for output of an output variable and at least one evaluation wit, the evaluation unit being configured such that it determines the measured variable from the output variable.

Monitoring the operating state of a pipeline system and in particular also the operating state of pump systems via a frequency analysis of vibrations which are characteristic of the component which is to be monitored, in particular of pipeline vibrations, by means of external sensors, for example, using a microphone. In doing so, what is used is that all mechanically movable parts which are connected to a pipeline also become noticeable in the frequency spectrum of the pipeline vibration. Thus, for example, sticking valves when activated generate vibrations other than slight. In this respect, changes in the frequency spectrum of the pipeline vibration can provide indications of possible defects in a system which cannot be detected, for example, via existing self-diagnoses of the system.

German Patent Application DE 10 2011 009 894 A1 and corresponding U.S. Pat. No. 8,820,176 B2 disclose a flow meter with a sensor unit for detecting parasitic vibrations which act on the flow meter. In doing so the parasitic vibrations which act on the flow meter proceed from pumps, turbines or valves operating in the pipeline system. The sensor unit is attached to the flow meter by means of an acoustic coupling and can thus optimally detect parasitic vibrations acting on the flow meter.

A method for monitoring the operating state of a pump is known to the applicant from practice. The method is based on the determination of a characteristic value of the pressure behavior or flow behavior in the pump system, for example, based on a frequency analysis, and on the subsequent comparison of this characteristic value to a specified characteristic value. The operating state of the pump can be determined from the comparison of the characteristic values.

The above described methods which are known from the prior art however have the disadvantage that, to monitor the respective system or pipeline, other external sensor units are used. In this respect the monitoring of the operating state of the systems is complex.

### SUMMARY OF THE INVENTION

Proceeding from the above described prior art, the primary object of this invention is to devise a method for detection of pipeline vibrations, and in this respect, for monitoring of the operating state of a pipeline system and/or of components which are connected to the pipeline system, which method is configured especially simply. Moreover, the object of this invention is to devise a corresponding measuring instrument.

The above described object is achieved according to a first teaching of the invention in the initially named method in that the measured variable characterizes the medium located within the pipeline system, that the sampling rate for detection of the input variable is at least twice as high as the frequency of the pipeline vibration of interest and the evaluation unit conducts a frequency analysis of the brief fluctuations of the measured variable.

It has been recognized that, with the invention, vibrations of a pipeline can not only be directly measured, therefore on the pipeline itself, but that they likewise act on other measured variables which characterize the medium located in the pipeline. These measured variables, therefore medium-measured variables, which are influenced by the pipe vibrations, are for example, the flow rate, in particular the volumetric flow rate or mass flow rate of a medium through a pipeline, the pressure or the temperature of the medium within the pipeline. In detail, the pipeline vibrations produce changes in the cross section of the pipeline which are accompanied by a change of the measured variables which characterize the medium. Here, those measured values which are connected to the medium and which are influenced by the pipeline vibrations are also of interest.

For example, if the pipe walls move apart during a vibration, the volume enclosed by the pipe become greater and the flow rate, the pressure and the temperature become lower. Conversely, if the cross section of the pipe narrows, the flow rate, the pressure and the temperature of the medium increase. The frequency of these brief fluctuations corresponds to the frequency of the pipeline vibration, which is normally in the kHz range. In this respect, pipeline vibrations are likewise detectable via brief fluctuations, for example, in the flow rate and/or in the pressure and/or in the temperature of the medium.

In order to be able to detect these brief fluctuations of the measured variable, the sampling rate according to the Nyquist-Shannon sampling theorem must be at least twice as high, preferably at least three times as high, especially preferably at least four times as high as the frequency of the pipeline vibration of interest. This ensures that the behavior of the measured variable can be reconstructed from the measured values which are discrete in time. Here the frequency of the pipeline vibration of interest is dependent on the respective pipeline system and the mechanical components connected to the pipeline system. The maximum frequency of the pipeline vibration of interest is ascertained in the method according to the invention before the measurement by the choice of the sampling rate. For example, if a pipeline vibration in the range of 800 Hz is expected, the sampling rate is at least 1600 Hz, preferably 2400 Hz, especially preferably 3200 Hz.

According to the invention the evaluation unit carries out a frequency analysis of the brief fluctuations of the measured variable. Defects of the pipeline system and/or of the components connected to the pipeline system result in a change in the vibration spectrum, for example, in the value of the frequencies or in their amplitude. In this respect, the operating state of the pipeline system and/or of the components connected to the pipeline system can be continuously monitored by the method of the invention without additional sensor units being necessary. If the method is cognitively configured, the quality of the determination of the measured variable can be greatly increased.

According to a first embodiment of the method, to determine the measured variable an averaging of at least two measured values of the measured variable is done. This has the advantage that the influence of the pipeline vibration can be eliminated by the averaging of several measured values of the measured variable. Moreover, generally the time constant of process-dictated changes of the measured variable is several orders of magnitude smaller than that of the parasitic vibrations so that the especially high time resolution of the measurement of the parasitic vibrations is not necessary for the determination of the measured variable.

It is especially advantageous if the frequency analysis takes place by a Fourier transform. In doing so, preferably, a frequency is defined as a monitoring parameter, whose change in the value or in the amplitude indicates a change of the pipeline system and/or of the components connected to the pipeline system. Furthermore, it is especially advantageous if the evaluation unit determines the frequency spectrum of the brief fluctuations of the measured variable by means of a Fourier transform. This is characteristic of the respective state of the pipeline system so that an especially accurate and reliable method for monitoring the pipeline system can be made available.

According to another advantageous embodiment of the invention, the measuring instrument has, in addition, a transmitting unit for emitting a measurement signal which has the input variable into the medium, the method of the invention having, in addition, the following method steps: emitting a measurement signal into the medium and receiving the transmission signal which has been transmitted through the medium by the transducer. The detection of the measured variable in this respect can take place either directly or based on the interaction of a measurement signal which has been emitted into the medium with the medium.

According to another advantageous configuration, the input variable is the propagation time a measurement signal and/or the phase of the measurement signal and/or the pressure of the medium and/or the deformation of a body located on the pipeline system and/or the phase of the pipe vibrations of the inlet-side and outlet-side regions of a pipe which has been set into vibrations, in particular the phase between the vibrations of the legs of a pipe bend which has been set into vibration. The method in accordance with the invention is especially advantageous in conjunction with a method for determining the volumetric or mass flow rate. Methods which can be combined with the method in accordance with the invention for determining the flow rate are for example, the propagation time measurement method, the determination of the mass flow based on the Coriolis principle or the determination of the velocity or of the volumetric flow using a vortex velocity flow meter. Any other method for determining a measured variable which characterizes the medium and which changes in the presence of a pipe vibration, the method being based on the detection of another input variable, is likewise suitable for combination with the method as claimed in the invention.

According to another embodiment, the measuring instrument is a flow meter. Alternatively, the measuring instrument is, for example, a pressure or temperature measuring instrument. According to another embodiment of the method, the transducer is a piezoelectric transducer and/or a detector coil and/or a strain gauge and/or pressure sensor and/or an ultrasonic transducer and/or a combination of the aforementioned sensors.

In order to further simplify the detection of a defect of the pipeline system or of components which are connected to the pipeline system, it is advantageous if the frequency spectrum of the vibration of the pipeline system in the defect-free state is filed in the evaluation unit and if the measured frequency and/or the measured frequency spectrum is compared to the frequency spectrum of the vibration of the pipeline system in the defect-free state. Alternatively or in addition, the frequency spectrum of the defect-free state at the start of the measurement can be re-recorded each time. A change of the frequency spectrum and in this respect a defect in the pipeline system can be recognized in this way especially easily and reliably.

According to another aspect of this invention, the initially named object is achieved by a measuring instrument in that the measuring instrument is configured for detecting a measured variable which characterizes the medium located within the pipeline system, that the evaluation unit is furthermore configured such that it carries out a frequency analysis of the brief fluctuations of the measured variable and that the sampling rate for detection of the input variable is at least twice as high as the frequency of the pipeline vibration of interest. The measuring instrument as claimed in the invention has the advantage that in operation it detects on the one hand the measured variable of interest, such as, for example, the volumetric or mass flow rate and/or the pressure and/or the temperature of the medium, and on the other at the same time monitors the operating state of the pipeline system and of the components which are connected to the pipeline system. In this respect, the pipeline system can be especially easily monitored.

The measuring instrument in accordance with the invention is, for example, a flow meter or a pressure or temperature measuring instrument or a combination of the two aforementioned measuring instruments.

It is especially advantageous if the evaluation unit is suitable for carrying out the above described method. With respect to the advantages of the corresponding configuration of the measuring instrument or of the evaluation unit reference is made to the advantages of the respective method.

Furthermore, it is advantageous if, in addition, there is a transmitting unit for emitting a measurement signal which has the input variable.

According to another advantageous embodiment of the measuring instrument as in accordance with the invention, the transducer is a piezoelectric transducer and/or a detector coil and/or a strain gauge and/or pressure sensor and/or an ultrasonic sensor or a combination of the aforementioned sensors.

At this point, there are various possibilities for configuring and developing the method and measuring instrument in accordance with the invention will be apparent from the following description of exemplary embodiments in conjunction with the accompanying drawings.

### BRIEF DESCRIPTION OF THE DRAWINGS

FIG. 1 shows a first exemplary embodiment of a method in accordance with the invention,

FIG. 2 shows a first exemplary embodiment of a measuring instrument in accordance with the invention based on ultrasonic waves in the medium,

FIG. 3 shows a second exemplary embodiment of a measuring instrument in accordance with the invention based on vortices produced in the medium and

FIG. 4 shows a third exemplary embodiment of a measuring instrument in accordance with the invention.

### DETAILED DESCRIPTION OF THE INVENTION

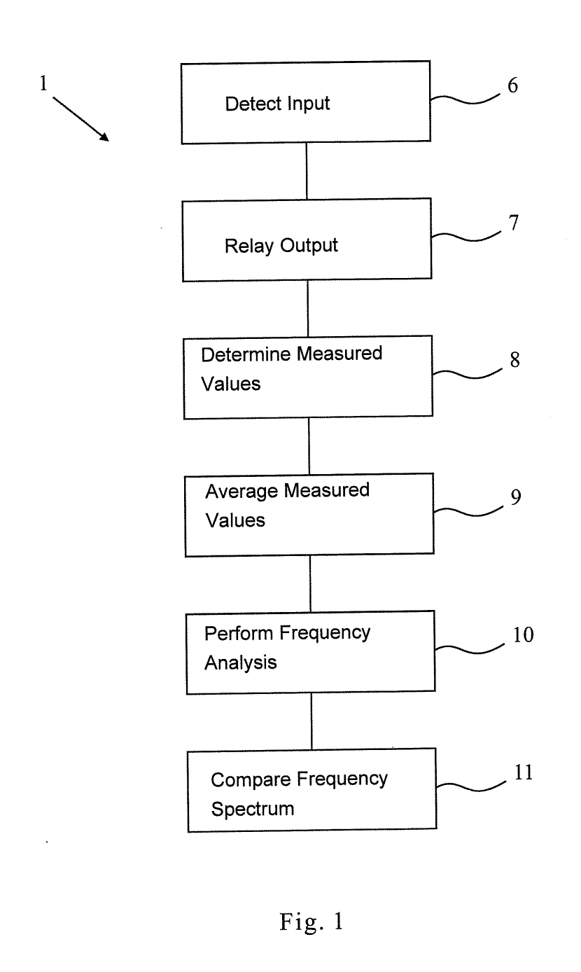

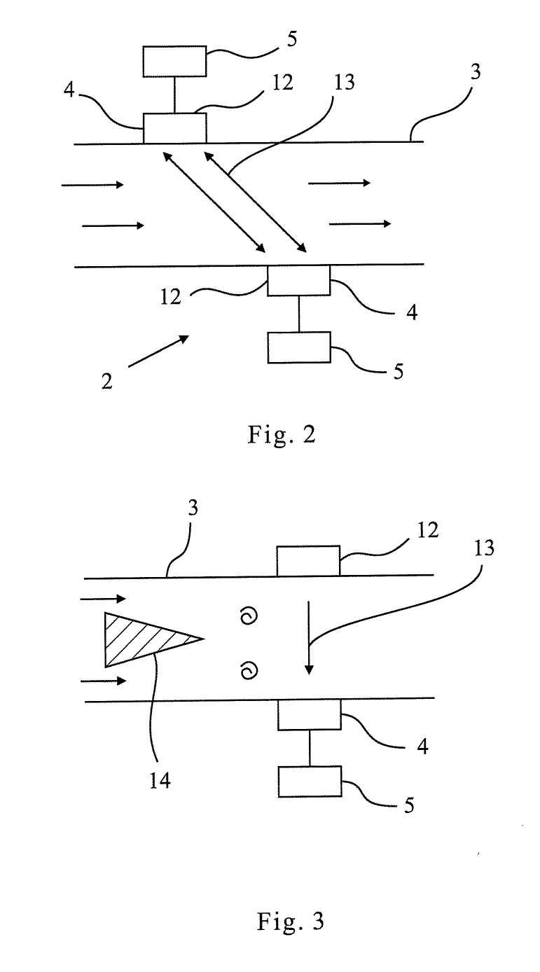

First of all, the method according to FIG. 1 is described, and with reference being made at the same time to the physical features which are shown in FIGS. 2 to 4.

A method 1 for detection of pipeline vibrations with a measuring instrument 2 for detecting a measured variable is shown and described in FIG. 1, for the case in which the measuring instrument 2 is attached to a pipeline system 3 through which the medium which is to be measured flows. The measuring instrument 2 has at least one transducer 4 for detection of an input variable and for output of an output variable, and at least one evaluation unit 5.

In a first step 6, the input variable is detected by the transducer 4 with a scanning rate which has been fixed beforehand. Then, in a next step 7, the transducer 4 relays an output variable which is based on the input variable to the evaluation unit 5. In a next step 8, the evaluation unit 5 determines a measured value of the measured variable from the output variable. In a next step 9, at least two measured values of the measured variable are averaged in order to be able to yield a noise-free value of the measured variable. Finally, in a next step 10, the evaluation unit 5 carries out a frequency analysis of brief fluctuations of the measured variable. In the illustrated exemplary embodiment, the evaluation unit 5 determines the frequency spectrum of the fluctuations.

In this method, the sampling rate for detection of the input variable is more than twice as high as the frequency f_{Pipe} of the pipeline vibration of interest. In this respect, it is ensured that the brief fluctuation of the measured variable which corresponds to a pipeline vibration can also be displayed time-resolved within the scope of this method.

In the illustrated method, the frequency spectrum of the brief fluctuations of the measured variable is determined. This frequency spectrum, in a next step 11, is compared to a frequency spectrum of the vibration of the pipeline system 3 in the defect-free state, which latter spectrum is filed in the evaluation unit 5. Changes in the frequency spectrum, for example, in the value or in the amplitude of the frequencies, indicate a defect in the pipeline system 3 or of components connected to the pipeline system 3. In this respect, the described method 1 constitutes an especially simple and reliable method for detection of pipeline vibrations 3 and for monitoring of the operating state of the pipeline system 3.

FIG. 2 shows a first exemplary embodiment of a measuring instrument 2 in operation which is suitable for carrying out a method as claimed in the invention for detection of pipeline vibrations. In this exemplary embodiment, the measuring instrument 2 is a flow meter which is attached to a pipeline system 3. A medium whose volumetric flow is being measured flows through the pipeline system 3 in this exemplary embodiment. The flow meter comprises a transmitting unit 12 for emitting a measurement signal which has the input variable, here, an ultrasonic signal 13, into the medium.

Moreover, the flow meter comprises a transducer 4 which is suitable for detection of the ultrasonic signal 13 with a fixed sampling rate and for output of an output variable to the evaluation unit 5. In this exemplary embodiment, the transducer 4 measures the propagation time of the ultrasonic signal 13 through the medium. Here, the transducer 4 is likewise made as a transmitting unit 12, and the transmitting unit 12 is likewise a transducer 4, both are ultrasonic transducers here. In this respect, using the measuring instrument 2 both the propagation time of the measurement signal in the flow direction of the medium and also oppositely to it are measured, the evaluation unit 5 being configured such that it determines the velocity from the propagation time difference and the flow rate of the medium therefrom.

Moreover, the evaluation unit 5 is also configured such that it carries out a frequency analysis of brief fluctuations of the flow rate and then compares the frequency spectrum which has been obtained in this way to a stored frequency spectrum which corresponds to the defect-free state.

In this respect, the described measuring instrument 2 can determine not only the flow rate of the medium, but at the same time can monitor the operating state of the pipeline system 3 or of components connected to the pipeline system 3 (such as, for example, pumps, valves, etc.).

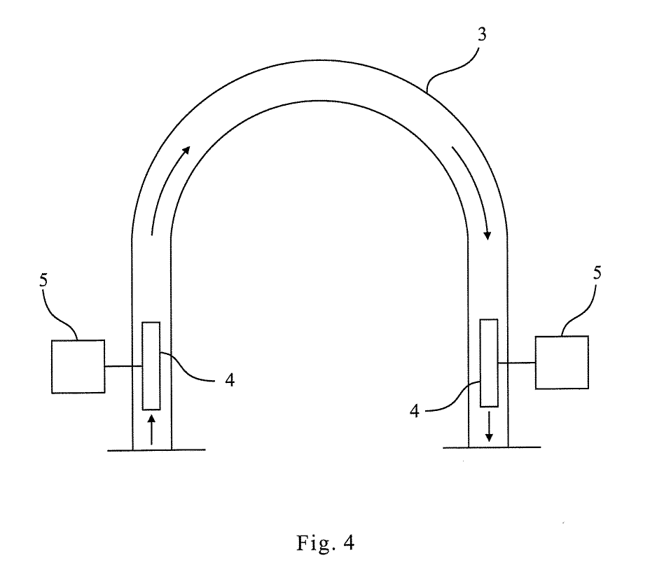

FIG. 3 shows a second exemplary embodiment of a measuring instrument 2 which is attached to a pipeline system 3, comprising a transmitting unit 12 for emitting a measurement signal which has the input variable into the medium, a transducer 4 and an evaluation unit 5. The measurement signal which has been emitted into the medium in this illustrated exemplary embodiment is likewise an ultrasonic signal 13.

As in the above described exemplary embodiment, the evaluation unit 5 determines both the flow rate of the medium through the pipeline system 3 and also the frequency spectrum of the vibration of the pipeline system 3 from the brief fluctuations of the flow rate. In this respect, the illustrated exemplary embodiment likewise has the advantage that, on the one hand, the measured variable, here the flow rate, is determined, and also at the same time the pipeline system 3 is monitored.

In the exemplary embodiment shown in FIG. 3, the flow rate is determined by the controlled excitation of vortices by a baffle barrier 14 in the medium which can be recorded as pressure or velocity fluctuations. Here both the transmitting unit 12 and also the transducer 4 are ultrasonic transducers, the transmitting unit 12 feeding ultrasonic signals 13 as measurement signals into the medium and the transducer 4 receiving the signals which have been transmitted through the medium. In passage through a vortex the transducer records a phase-modulated signal, as a result of which the vortex frequency and in this respect the velocity of the medium can be determined.

FIG. 4 likewise shows a measuring instrument 2 which is attached to a pipeline system 3, comprising two transducers 4, here two strain gauges, and two evaluation units 5. In the illustrated exemplary embodiment the pipeline system 3 is made u-shaped, one transducer 4 and one evaluation unit 5 being attached to each leg. Here, to determine the flow rate, the pipeline system 3 through which the medium has flowed is set into vibration, the strain gauges detecting the vibrations of the respective legs. The mass flow rate is determined according to the Coriolis principle by a comparison of the phases of the vibrations of the legs.

At the same time, the evaluation units 5 determine the frequency spectrum of a brief fluctuation of the flow rate. In this respect, the exemplary embodiment of a measuring instrument 2 described here is suitable for both determining the flow rate of the medium through the pipeline system 3, and also at the same time, for monitoring the operating state of the pipeline system 3.

What is claimed is:

1. A method for detection of pipeline vibrations with a measuring instrument for detecting a measured variable, the measuring instrument being connected to a pipeline system through which the medium which is to be measured flows, and the measuring instrument having at least one transducer for detection of an input variable and for output of an output variable and at least one evaluation unit, comprising the following method steps:
detecting the input variable by the transducer,
relaying an output variable based on the input variable to the evaluation unit,
determining the measured value of the measured variable from the output variable with the evaluation unit,
wherein the measured variable a medium located within the pipeline system,
wherein said detecting of the input variable is performed with a sampling rate that is at least twice as high as a frequency f_{Pipe} of pipeline vibration and
wherein the evaluation unit conducts a frequency analysis of brief fluctuations of the measured variable.

2. The method as claimed in claim 1, wherein for determination of the measured variable, an averaging of at least two measured values of the measured variable is performed.

3. The method as claimed in claim 1, wherein the measured variable is at least one of a flow rate of the medium, a pressure of the medium and a temperature within the medium.

4. The method as claimed in claim 1, wherein the frequency analysis is performed using a Fourier transform.

5. The method as claimed in claim 1, wherein a frequency or frequency spectrum is determined by means of the frequency analysis.

6. The method as claimed in claim 1, wherein the measuring instrument has a transmitting unit for emitting a measurement signal which has the input variable into the medium, and wherein the method has the following addition method steps:
emitting a measurement signal into the medium, and
receiving a transmission signal which has been transmitted through the medium by the transducer.

7. The method as claimed in claim 1, wherein the input variable is at least one of a propagation time of a measurement signal, a phase of the measurement signal, a pressure of the medium, a deformation of a body located on the pipeline system, and a phase of pipe vibrations of inlet-side and outlet-side regions of a pipe which has been set into vibrations.

8. The method as claimed in claim 1, wherein the at least one transducer is at least one of a piezoelectric transducer, a detector coil, a strain gauge, a pressure sensor, and an ultrasonic.

9. The method as claimed in claim 1, wherein a frequency spectrum of vibration of the pipeline system in a defect-free state is stored in the evaluation unit and wherein at least one of measured frequency and measured frequency spectrum is compared to the stored frequency spectrum of the vibration of the pipeline system in the defect-free state.

10. A measuring instrument for detection of a measured variable and constructed for attachment to a pipeline system through which a medium to be measured flows, comprising
at least one transducer adapted for detection of an input variable and for output of an output variable and
at least one evaluation unit, the evaluation unit being configured determining a measured variable characteristic of the medium flowing within the pipeline system from the output variable, and for carrying out a frequency analysis of brief fluctuations of the measured variable,
wherein the at least on transducer has a sampling rate for detection of the input variable that is at least twice as high as a frequency f_{Pipe} of a pipeline vibration of interest.

11. The measuring instrument as claimed in claim 10, wherein at least one transduce is adapted to detect at least one of a propagation time, a phase of a measurement signal, a pressure of the medium, a deformation of a body located on the pipeline system, and a phase of pipe vibrations of inlet-side and outlet-side regions of a pipe which has been set into vibrations as the input variable.

12. The measuring instrument as claimed in claim 10, wherein the measuring instrument is at least one of a flow rate measuring instrument and a pressure measuring instrument.

13. The measuring instrument as claimed in claims 10, further comprising at least one transmitting unit for emitting a measurement signal containing the input variable.

14. The measuring instrument as claimed in claims 10, wherein the at least one transducer is at least one of a piezoelectric transducer, a detector coil, a strain gauge, a pressure sensor and an ultrasonic transducer.
